(19) United States
(12) Patent Application Publication
(10) Pub. No.: US 2009/0265874 A1
(43) Pub. Date: Oct. 29, 2009

(54) BALANCED LONGITUDINAL ANTI-FLAT SPOTTING DEBRIS EVACUATOR SYSTEM

(76) Inventors: Gregory Krantz, Williams Bay, WI (US); Dennis Rockwell, Kansasville, WI (US); David Houcque, Elkhorn, WI (US)

Correspondence Address: STELLANA U.S., 999 WELLS STREET, LAKE GENEVA, WI, 53147, US

(21) Appl. No.: 12/110,142

(22) Filed: Apr. 25, 2008

(51) Int. Cl. B08B 17/02; B08B 1/00

(52) U.S. Cl. 15/236.06; 15/256.51; 134/33

(57) ABSTRACT

This specification relates to the improvement of load wheels. During use, load wheels become embedded with debris. The debris causes flat spots on the wheel. The invention eliminates flat spots by evacuating debris away from the load wheel.

### BACKGROUND OF THE INVENTION

This invention pertains to load wheels for material handling vehicles, and more particularly to improving the service life of the load wheel by preventing premature failure. Load wheels are a device with no individual moving parts. Load wheels are used in Class II material handing vehicles; for example, a fork lift or an order picker. Load wheels are also used in Class III material handing vehicles such as, a pallet jack or lift truck. Load wheels are used to support the material moved or handled by the truck or vehicle. Unlike tires, load wheels do not brake, articulate, or turn.

During use, load wheels pick up dust, dirt and other fine particles from the floor. Fine debris such as dust and dirt generally do not harm a load wheel. Small debris such as nails, screws, bits of metal, wood, concrete, stones and pebbles, however, are harmful to load wheels. Small debris become imbedded into the load wheel, and causes the load wheel to go out of round. Once out of round, the wheel develops a flat spot.

Once a flat spot develops, increased stress is imparted to the load wheel causing the tread material separate from the hub. Once the tread material separates from the hub, the load wheel is unusable and must be replaced. In addition to ruining the load wheel, flat spotting is detrimental to the ride of the material handling vehicle. The poor ride makes the lift material difficult to handle and presents a safety concern if the poor ride destabilizes the load carried by the vehicle.

The invention described herein prevents debris, such as nails and screws, from becoming embedded into load wheels. The invention prevents debris from becoming embedded into load wheels by sweeping the debris out of the path of the load wheel as it traverses the floor. By sweeping the debris from the path of the load wheel, the debris will not become embedded in the load wheel tread material, thereby preventing the wheel from going out of round.

The invention is superior to other methods that may be used to prevent material from being embedded into the load wheel. For example a fixed scraper could be placed in front of the load wheel to deflect debris out of the path of the load wheel. Another approach would be to place a brush like device in front of the load wheel. Both devices could deflect debris, but each has its shortcomings compared to the invention described herein.

A fixed scraper cannot articulate over obstructions commonly encountered in a material handling environment. For example, a scraper blade may get caught on the bottom cross member of a shipping pallet or a loading dock plate. Increasing the clearance between the floor and the scraper blade would reduce the efficiency of the scraper blade to clear materials from the path of the load wheel. Furthermore, debris could become wedged between the floor and the scraper blade requiring the operator to stop and remove the debris.

Using a brush device would solve the clearance problem inherent to using a fixed scraper blade. However, bristles of the brush will become saturated and will no longer catch debris until they are replaced or cleaned. In addition, rigid pieces of debris may simply push their way through the bristles and become embedded into the load wheel.

The invention described herein alleviates both these problems by careful articulation of the debris evacuator. By carefully controlling the amount of articulation of the evacuator, debris can be deflected from the load wheel surface; while at the same time, the load wheel will be free to move over other obstacles such as pallet support members and loading dock plates. By allowing the debris evacuator to articulate, the shortcomings of a scraper blade or brush are eliminated.

### SUMMARY OF THE INVENTION

In accordance with the preferred embodiment of this invention, it is now possible to increase the service life of load wheels by preventing flat spotting. Flat spotting, caused by debris being embedded in the wheel, is prevented by placing a debris evacuator in front of and behind the load wheel. The invention deflects debris away from the load wheel, while at the same time allowing the load wheel to roll over obstacles such as pallet cross members and loading dock plates.

### BRIEF DESCRIPTION OF THE DRAWINGS

FIG. 1 is an inverse isometric view of a debris evacuator installed in a fork of a material handling vehicle.

FIG. 2 is an inverse top down view of a debris evacuator installed in a fork of a material handling vehicle.

FIG. 3 is an inverse side view of a debris evacuator installed in a fork of a material handling vehicle.

FIG. 4 is an isometric view of the debris evacuator installed around a load wheel assembly.

FIG. 5 is an exploded view of the debris evacuator installed around a load wheel assembly.

FIG. 6 is an exploded view of the of the second embodiment debris evacuator.

FIG. 7 is an isometric view of the second embodiment of the debris evacuator.

FIG. 8 is an isometric view of the second embodiment of the debris evacuator.

FIG. 9 is an isometric view of the second embodiment of the debris evacuator.

FIG. 10 is an isometric view of debris evacuator.

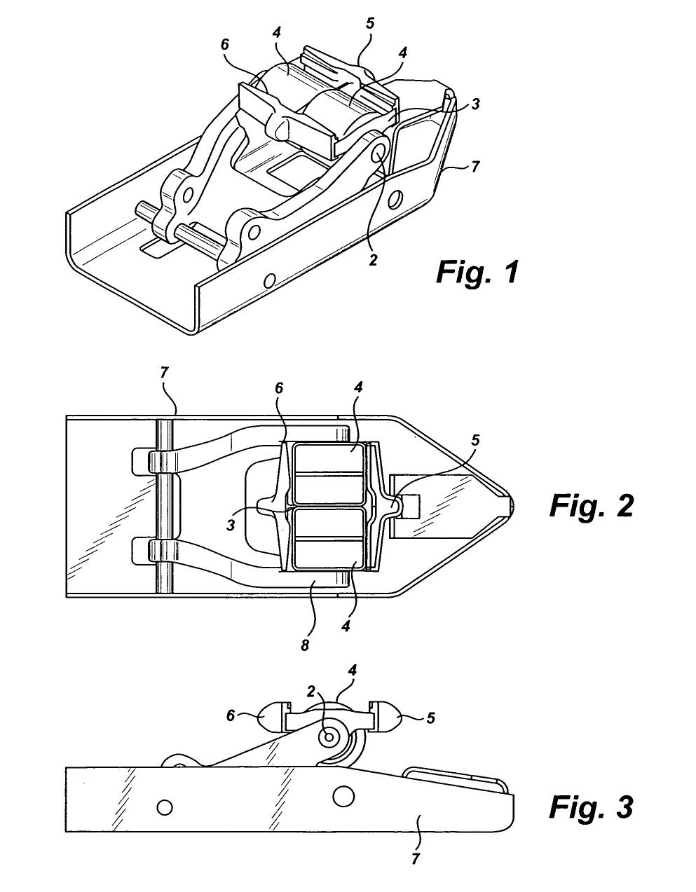

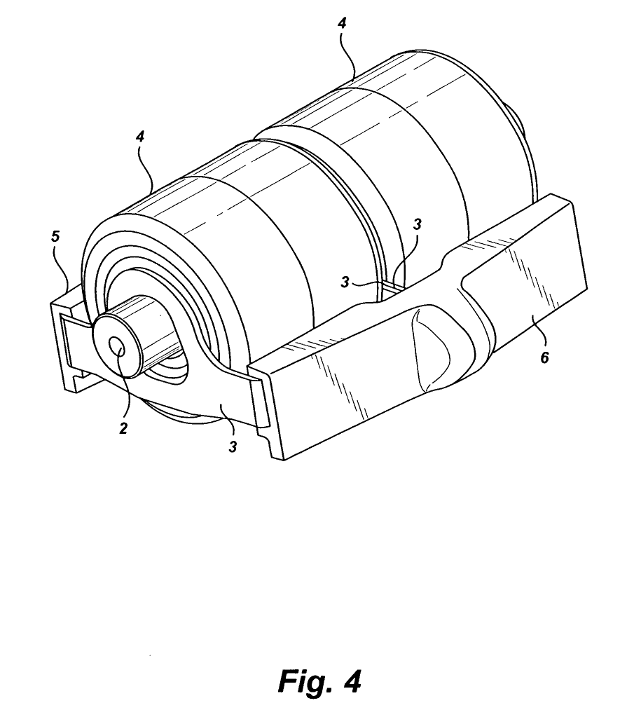

### DESCRIPTION OF THE PREFERRED EMBODIMENT

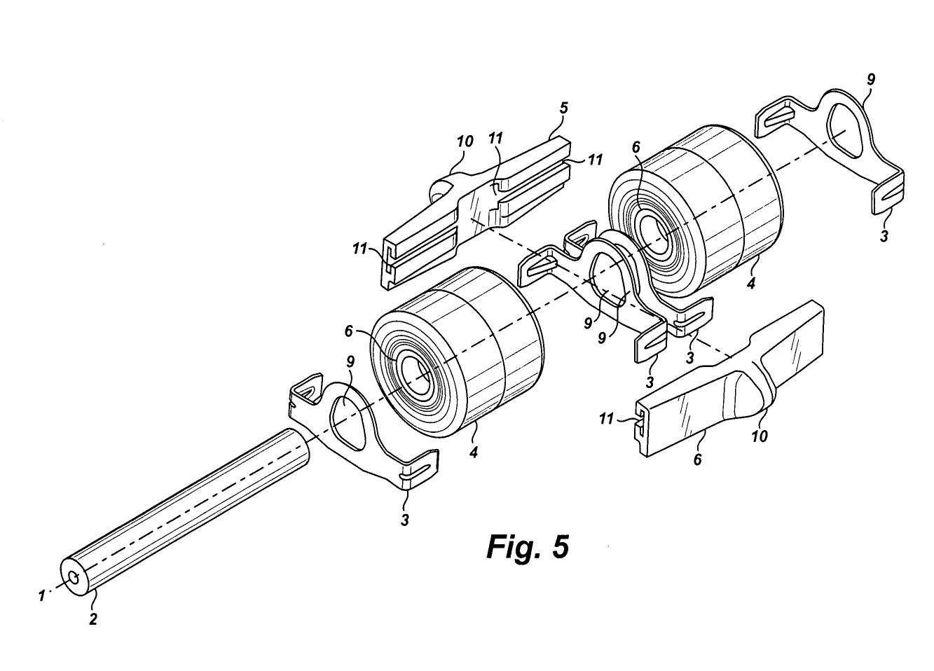

The following example is submitted to illustrate but not to limit this invention. Referring to FIG. 5, a debris evacuator comprises an articulating assembly and a front and rear blade. In the first embodiment of the invention, the articulating assembly comprises four articulating brackets 3. Two of the articulating brackets 3 are placed on the outside of the load wheels, and two are placed on the inside of the load wheels. The articulating brackets line up along the longitudinal axis 1 defined along the openings of the load wheel hubs. The brackets should have an opening 9 that will admit the through shaft for the load wheel assembly. The opening 9 should be of sufficient size to allow the bracket to articulate about the shaft by at least a quarter of an inch. The brackets are the sliding fitted into a slot 11 on the back the front blade 5 and the rear blade 6. The articulating brackets 3 and the front blade 5 and rear blade 6 proscribe an inner area into which a load wheel 4 is placed. A through shaft 2 is slidingly fitted along the longitudinal axis 1 through the openings in the articulating brackets 9 and the load wheel hubs 6. Both the front blade 5 and rear blade 6 should be curved to evacuate debris away from the load wheel as the load wheel moves across the floor. In the center of both the front blade 5 and the rear blade 6, a nose lifting assembly 10 is placed to aid in articulating the blades upward when the blade encounters a pallet support member or a loading dock plate.

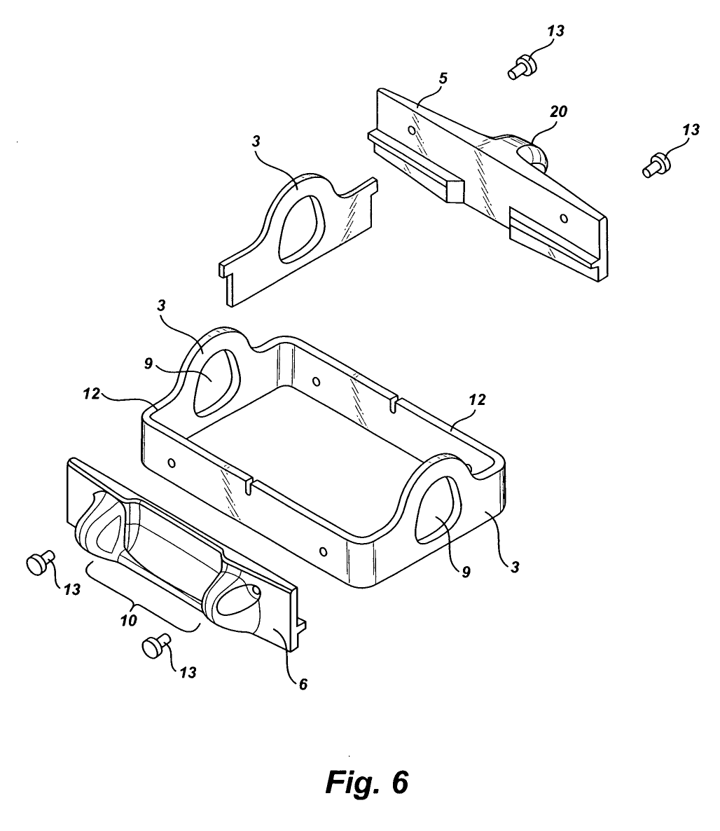

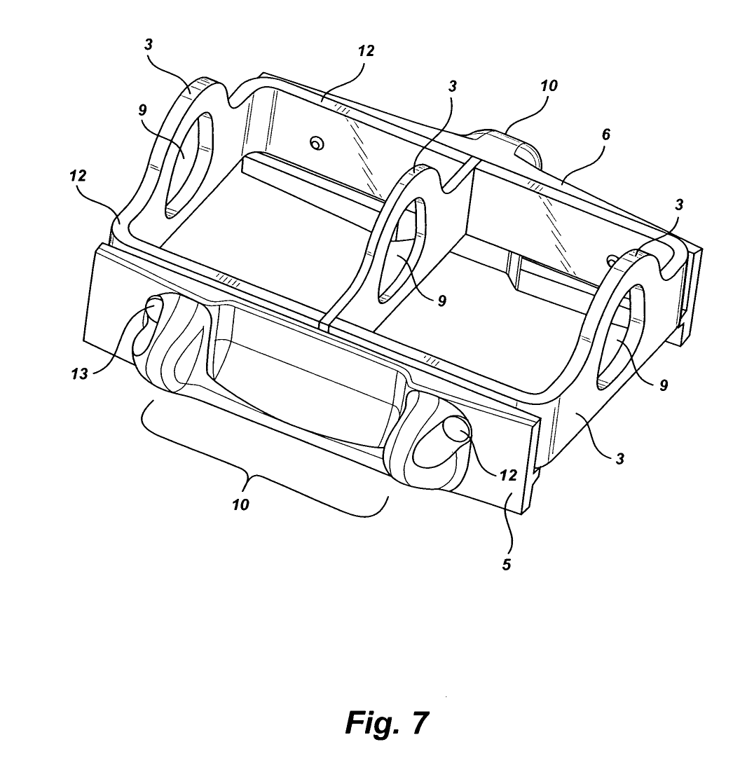

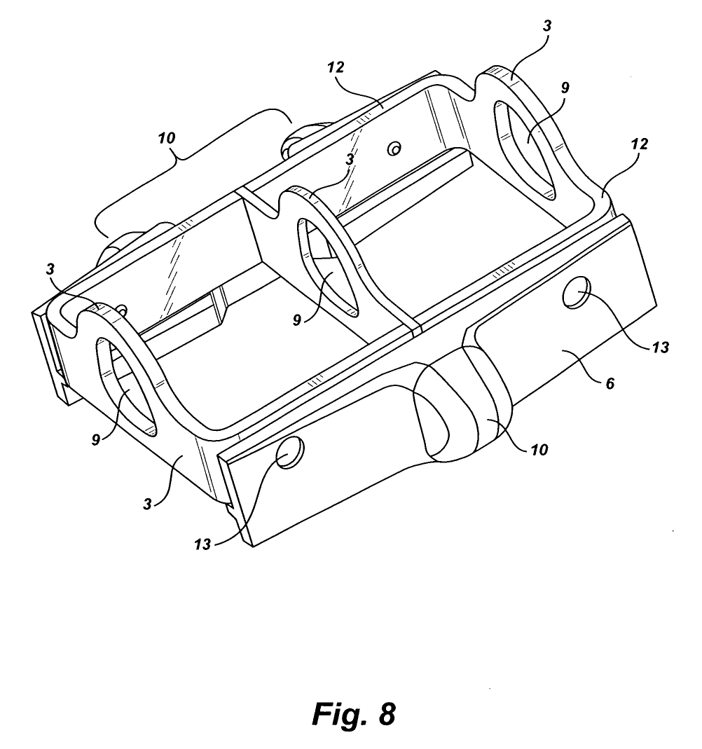

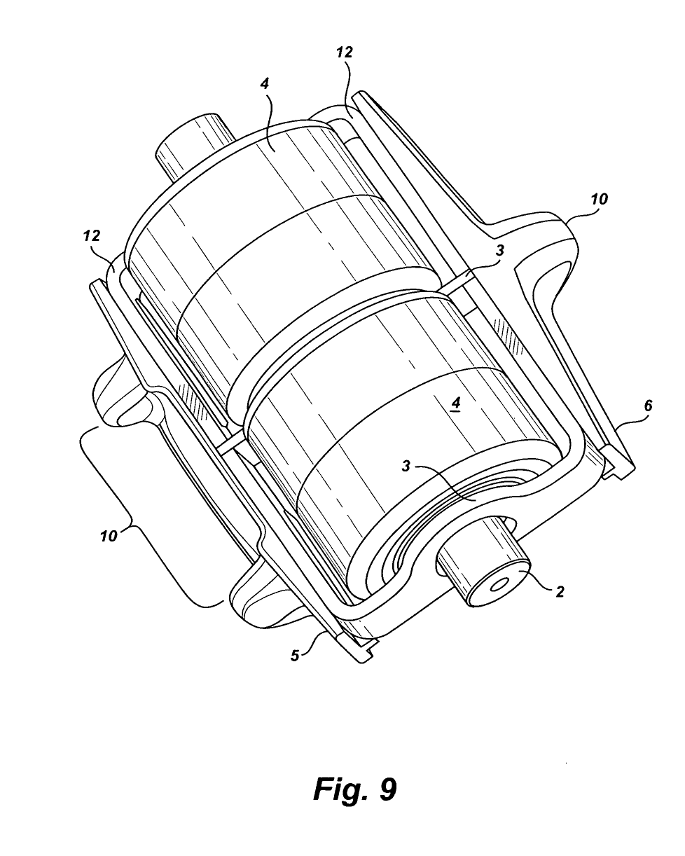

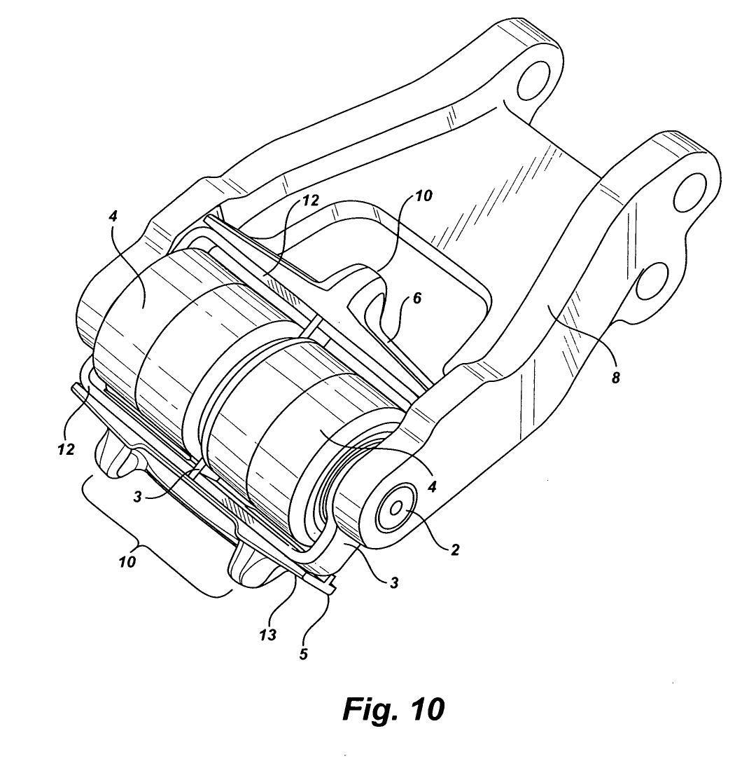

In a second embodiment of the invention, FIGS. 6-10 the articulating assembly is of a unitary construction; that is the articulating brackets 3 are fabricated from a single piece of metal or made from separate pieces of metal and rigidly joined together using a cross member 12. For a two wheel assembly, only three articulating brackets 3 are used. The front blade 5 and the rear blade 6 are attached to the articulating assembly cross members using a fastener 13 or an adhesive.

Having set forth the general nature and specific embodiments of the present invention, the true scope is now particularly pointed in the appended claims.

What is claimed is:

1) A debris evacuator comprising:
a) an articulating assembly; wherein
b) said articulating assembly further comprises at least two articulating brackets; and
c) a front blade having a first end and a second end and a front side and a back side; and a rear blade having a first end and a second end and a front side and a back side; and wherein the backside of said front blade and said rear blade having at least one slot having an inner dimension open at the first end and said second end of said front blade and said rear blade; and
d) wherein said first articulating bracket is sliding fitted into said inner dimension of said slot opening of said first end of said front blade means and said inner dimension of said slot opening of said first end of said rear blade; and
e) wherein said second articulating bracket is sliding fitted into said inner dimension of said slot opening of said second end of said front blade and said inner dimension of said slot opening of said second end of said rear blade; and
f) wherein said first articulating bracket, said rear blade, said second articulating bracket and said first blade define an open space with an inner dimension; and
g) wherein said inner dimension of said open space is sufficient to admit and allow free rotation of at least one provided load wheel.

2) A debris evacuator comprising:
a) an articulating assembly of unitary construction with at least two articulating brackets wherein said articulating brackets are placed opposite of each other and rigidly affixed to each other by at least two rigid cross members;
b) wherein said articulating brackets and said cross members define an open space having an inner dimension; and
c) wherein said inner diameter of said open space is sufficient to admit and allow free rotation of at least one provided load wheel; and
d) a front blade having a front side and a back side; and a rear blade having a front side and a back side; and wherein said front blade is affixed to one rigid cross member and said rear blade is affixed to said second rigid cross member.

3) The debris evacuator of claims 1 or 2 wherein said front side of said front blade and said rear blade are curved to promote the deflection of debris.

4) The debris evacuator of claims 1 or 2 wherein said front blade and said rear blade has a nose shaped lifting means to aid in the articulation of said front blade and said rear blade.

5) The debris evacuator of claim 3 wherein said front blade and said rear blade has a nose-shaped lifting means to aid in the articulation of said front blade and said rear blade.

6) A method for preventing flat spotting of load wheels by installing the debris evacuator assembly as in one of claims 1-5 into the mounting yoke of a Class II material handling vehicle, and operating said Class II material handling vehicle in accordance with the manufacturer's instructions.

7) A method for preventing flat spotting of load wheels by installing the debris evacuator assembly as in one of claims 1-6 into the mounting yoke of a Class III material handling vehicle, and operating said Class III material handling vehicle in accordance with the manufacturer's instructions.
